(19) United States
(12) Patent Application Publication
(10) Pub. No.: US 2020/0052598 A1
(43) Pub. Date: Feb. 13, 2020

(54) VOLTAGE SENSE CONTROL CIRCUIT, VOLTAGE SENSE CONTROL METHOD AND ISOLATED CONVERTER THEREOF

(71) Applicant: Silergy Semiconductor Technology (Hangzhou) LTD, Hangzhou (CN)

(72) Inventors: Shaobin Zhang, Hangzhou (CN); Xiaoru Xu, Hangzhou (CN); Zhiliang Hu, Hangzhou (CN); Yongjiang Bai, Hangzhou (CN)

(21) Appl. No.: 16/657,461

(22) Filed: Oct. 18, 2019

Related U.S. Application Data
(63) Continuation of application No. 15/200,127, filed on Jul. 1, 2016, now abandoned.

(30) Foreign Application Priority Data
Jul. 24, 2015 (CN) 201510443564.7

(51) Int. Cl. H02M 3/335

(52) U.S. Cl. CPC H02M 3/33507; H02M 2001/0009

(57) ABSTRACT

A voltage sense control circuit configured for an isolated converter can include: a current sampling and holding circuit configured to sample a current through a power switch to obtain a voltage sense signal that represents current information of the power switch, where the voltage sense signal is in proportion to a forward voltage drop of a rectifier device; a compensation signal generating circuit configured to generate a first current signal according to the voltage sense signal, and to generate a compensation signal according to the first current signal to compensate an output voltage feedback signal of the isolated converter to obtain a voltage feedback signal; and a voltage sampling and holding circuit configured to sample and hold the voltage feedback signal to regulate an output voltage of the isolated converter to be stable.

### RELATED APPLICATIONS

This application claims the benefit of Chinese Patent Application No. 201510443564.7, filed on Jul. 24, 2015, which is incorporated herein by reference in its entirety.

### FIELD OF THE INVENTION

The present invention generally relates to the field of power supplies, and more particularly to voltage sense control circuits, methods, and an associated isolated power converter.

### BACKGROUND

A primary side regulated (PSR) control method may be used in isolated switching power supplies with intermediate and relatively small power capacities because of simple circuit structure, good safety performance, and so on. Typically, a PSR control circuit operates in a current discontinuous mode (DCM) or a quasi-resonant mode (QR), which controls a switching power supply at a primary side via an auxiliary winding coupled with a transformer. An output voltage of the switching power supply can be sampled when a rectifier diode at a secondary side stops freewheeling current. This can obtain good regulation of the output voltage by ignoring the influence on the sampling precision caused by a forward voltage drop of the rectifier diode.

### BRIEF DESCRIPTION OF THE DRAWINGS

FIG. 1 is a schematic block diagram of an example primary side regulated control circuit with voltage and current detection.

FIG. 2 is a waveform diagram of an example sense signal of an output voltage when the primary side regulated control circuit shown in FIG. 1 operates in a quasi-resonant mode.

FIG. 3 is a waveform diagram of an example sense signal of an output voltage when the primary side regulated control circuit shown in FIG. 1 operates in a current continuous mode.

FIG. 4 is a schematic block diagram of a first example voltage sense control circuit, in accordance with embodiments of the present invention.

FIG. 5 is a waveform diagram of example operation of the first example voltage sense control circuit, in accordance with embodiments of the present invention.

FIG. 6 is a schematic block diagram of a second example voltage sense control circuit, in accordance with embodiments of the present invention.

FIG. 7 is a waveform diagram of example operation of the second example voltage sense control circuit, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

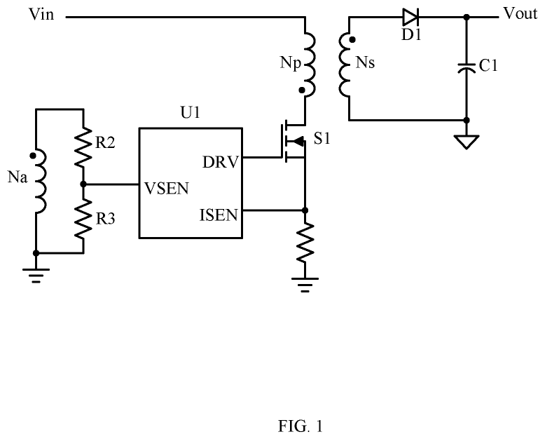

Referring now to FIG. 1, shown is a schematic block diagram of an example primary side regulated control circuit with voltage and current detection. Here, an auxiliary winding Na is coupled to a secondary winding Ns to obtain information as to an output voltage. Resistors R2 and R3 can be used to sample a voltage across auxiliary winding Na, in order to generate sense signal Vsen that represents the output voltage.

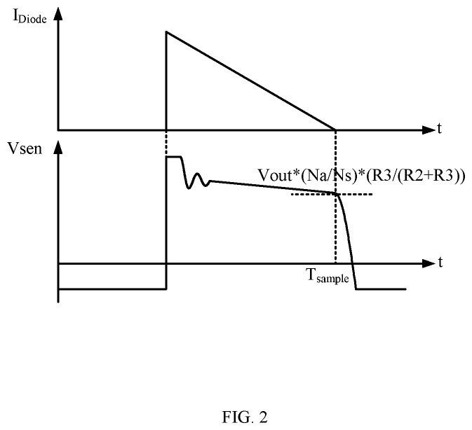

Referring now to FIG. 2, shown is a waveform diagram of an example sense signal of an output voltage when the primary side regulated control circuit shown in FIG. 1 operates in a quasi-resonant mode. When the system operates in a quasi-resonant mode (QR), the waveform of the sense signal obtained by primary-side regulated control can be shown, and the value of the sense signal received by a primary-side controller can be (Vout+VF)*(Na/Ns)*(R3/(R2+R3)). A forward voltage drop VF of freewheeling diode D1 may be ignored at sampling moment Tₛₐₘₚₗₑ at which a current through the freewheeling diode D1 is reduced to zero. So, the value of the sense signal can be approximately Vout*(Na/Ns)*(R3/(R2+R3)). Thus, good regulation of the output voltage can be achieved in the quasi-resonant mode by adopting such primary side regulation control.

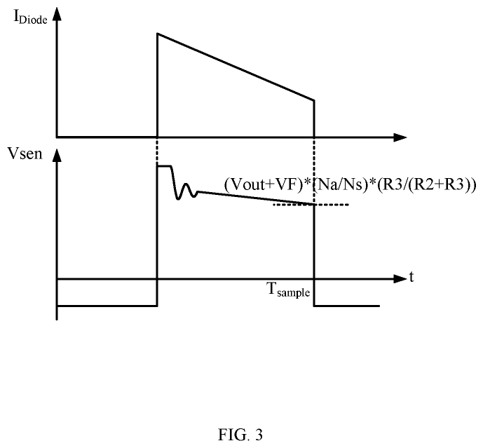

Referring now to FIG. 3, shown is a waveform diagram of an example sense signal of an output voltage when the primary side regulated control circuit of FIG. 1 operates in a current continuous mode (CCM). The system may operate in CCM in order to reduce the primary and secondary side current stresses in applications with relatively large power capacity. FIG. 3 shows a waveform of the sense signal obtained by primary-side regulated control in the CCM. When the primary-side regulated control circuit operates in CCM, the current through secondary side freewheeling diode D1 is not zero at the sampling moment Tₛₐₘₚₗₑ. So, forward voltage drop VF of the freewheeling diode may vary along with the variation of the current through the freewheeling diode. As a result, the sampling precision for the output voltage may be adversely affected. Thus, good regulation of the output voltage in different modes including CCM, current discontinuous mode (DCM), and quasi-resonant mode (QR) may be difficult to achieve by applying such a primary-side regulated control circuit.

In one embodiment, a voltage sense control circuit configured for an isolated converter having a transformer that includes a primary winding and a secondary winding, a power switch coupled to the primary winding, and a rectifier device coupled to the secondary winding, where the voltage sense control circuit, can include: (i) a current sampling and holding circuit configured to sample a current through the power switch to obtain a voltage sense signal that represents current information of the power switch, where the voltage sense signal is in proportion to a forward voltage drop of the rectifier device; (ii) a compensation signal generating circuit configured to generate a first current signal according to the voltage sense signal, and to generate a compensation signal according to the first current signal to compensate an output voltage feedback signal of the isolated converter to obtain a voltage feedback signal; and (iii) a voltage sampling and holding circuit configured to sample and hold the voltage feedback signal to regulate an output voltage of the isolated converter to be stable.

In one embodiment, a voltage sense control method configured for an isolated converter having a transformer that includes a primary winding and a secondary winding, a power switch coupled to the primary winding, and a rectifier device coupled to the secondary winding, can include: (i) sampling a current through the power switch to obtain a voltage sense signal in proportion to a voltage drop of the rectifier device; (ii) generating a first current signal according to the voltage sense signal; (iii) generating a compensation signal according to the first current signal for compensating an output voltage feedback signal to obtain a voltage feedback signal; and (iv) sampling and holding the voltage feedback signal for regulating an output voltage of the isolated converter to be stable.

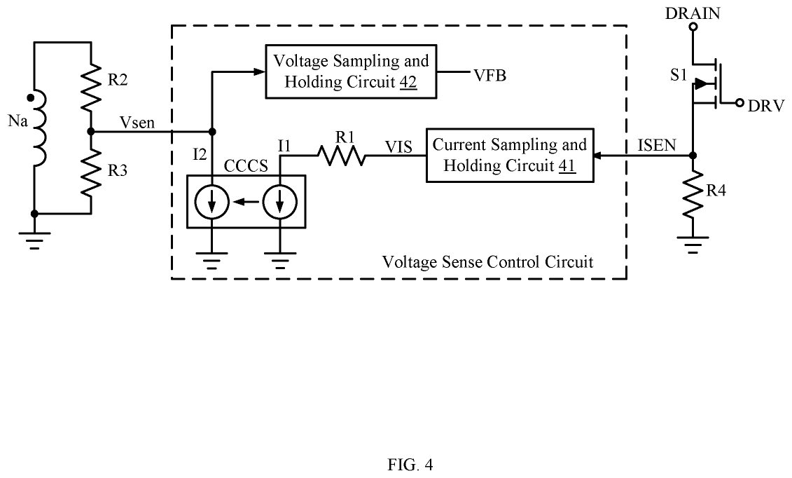

Referring now to FIG. 4, shown is a schematic block diagram of a first example voltage sense control circuit, in accordance with embodiments of the present invention. In this particular example, the voltage sense control circuit may be applied in an isolated converter, such as a flyback converter in order to receive input voltage signal Vin, and provide stable output voltage Vout for a load. For example, the flyback converter may include a transformer having primary winding Np and secondary winding Ns, power switch S1 coupled to primary winding Np, and a rectifier device coupled to secondary winding Ns.

In this particular example, the rectifier device is described as a rectifier diode having an anode coupled to secondary winding Ns, and a cathode coupled to the load at an output terminal. In FIG. 4, the flyback switching power supply also includes an output voltage feedback circuit having auxiliary winding Na and voltage dividing resistors R2 and R3, for generating output voltage feedback signal Vsen.

In this example, the flyback switching power supply may also include a voltage sense control circuit that includes current sampling and holding circuit 41, a compensation signal generating circuit, and voltage sampling and holding circuit 42. The compensation signal generating circuit may include resistor R1 and current controlled current source CCCS. Resistor R1 can connect between current sampling and holding circuit 41, and current controlled current source CCCS. One skilled in the art will recognize that the positions of resistor R1 and current controlled current source CCCS may switch their positions.

Current sampling and holding circuit 41 may be used to obtain voltage sense signal VIS by sampling a current through the power switch. Voltage sense signal VIS may be converted to current signal I1 through resistor R1. Current controlled current source CCCS may receive current signal I1 and generate current signal I2 that is in proportion to current signal I1 Also, an output terminal (e.g., a common node of voltage dividing resistors R2 and R3) of the current controlled current source can connect to an output terminal of the output voltage feedback circuit. Further, a compensation signal can be generated according to a voltage drop obtained by current signal I2 flowing through resistors R2 and R3.

In certain embodiments, compensating the output voltage feedback signal by the compensation signal may include adding the voltage drop generated by current signal I2 flowing through the voltage dividing resistors to the output voltage feedback signal, in order to generate voltage feedback signal VFB. Voltage sampling and holding circuit 42 can sample and hold voltage feedback signal VFB at the current moment, for regulating the output voltage of the isolated converter to be substantially stable.

If the current of secondary side D1 is not zero, the diode may have a voltage drop. The output voltage feedback signal before compensation process may be calculated as VFB=(Vout+VF)*(Na/Ns)*(R3/(R2+R3)), so the output voltage feedback signal may not precisely represent output voltage Vout due to the forward voltage drop VF of the diode. Thus, since a current through the primary side switch is in proportion to a current through the secondary side diode, and the voltage drop of the secondary side diode is in proportion to its current, the voltage drop of the secondary side diode can be represented by voltage sense signal VIS generated via sampling the current through the primary side switch. Thus, the compensation signal generated according to voltage sense signal VIS may be used to essentially cancel out the influence on the output voltage feedback signal caused by the voltage drop of the diode, and voltage feedback signal VFB for precisely representing the output voltage can be obtained.

In this example, the compensation signal can be regulated by changing the value of resistor R1. The proportion factor of the current controlled current source and/or the values of the voltage dividing resistors in the output voltage feedback circuit can be changed in different applications such that the secondary side diode has different voltage drops. In this way, the voltage drop of the diode can be canceled in various applications.

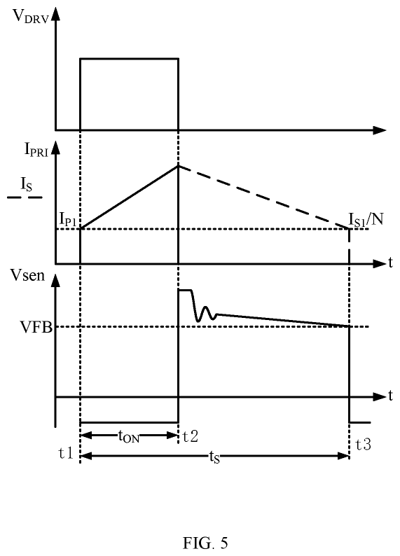

Referring now to FIG. 5, shown is a waveform diagram of example operation of the first example voltage sense control circuit, in accordance with embodiments of the present invention. Here, tₛ may denote one switching cycle, t1 may denote the turn on time of the power switch at the primary side, t2 can denote the turn off time of the power switch, and the freewheeling current can begin to flow through the secondary side diode from time t2 until one switching cycle ends at time t3. This example operation mode may be a current continuous mode.

In this example, at the turn on time of the power switch, at time t1, current sampling and holding circuit 41 may be used to sample the current through the power switch, in order to generate voltage sense signal VIS (e.g., VIS=I_{P1}×R4, where I_{P1} denotes the current through the power switch) when diode D1 stops operation in discontinuous current mode or quasi-resonant mode, or when the switching cycle of the power switch completes in the continuous current mode. At time t3, voltage sampling and holding circuit 42 may be used to sample and hold voltage feedback signal VFB.

Primary current I_{P1} at the current sampling moment can be equal to peak current IS1 of the secondary side diode at the moment of sampling the output voltage divided by a turn ratio of the primary winding to the secondary winding (e.g., I_{P1}=I_{S1}/N, where N=Np/Ns). Thus, current information of the secondary side diode can be determined according to sense voltage signal VIS. That is, sense voltage signal VIS may be used to represent forward voltage drop VF of the secondary side diode. Thus, voltage feedback signal VFB excluding the voltage drop of the secondary side diode may be obtained by generating a compensation signal according to sense voltage signal VIS, in order to cancel out the influence on the output voltage feedback signal at the moment of sampling the output voltage caused by the voltage drop of the secondary side diode. In this way, the output voltage of the isolated converter may be precisely controlled according to voltage feedback signal VFB, in order to achieve good regulation.

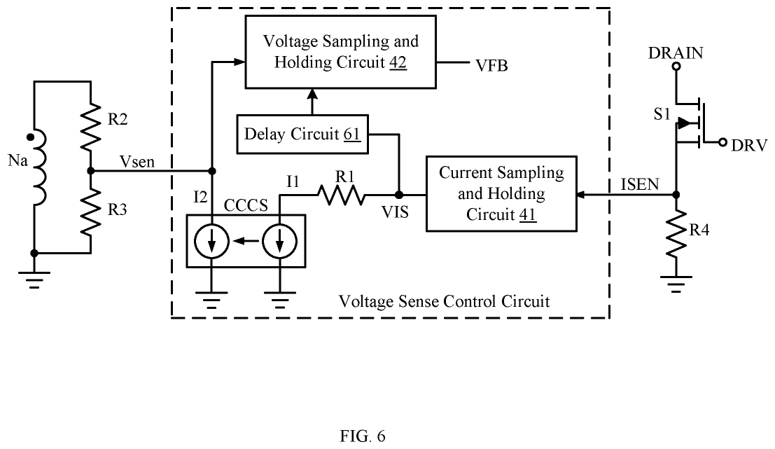

Referring now to FIG. 6, shown is a schematic block diagram of a second example voltage sense control circuit, in accordance with embodiments of the present invention. In this particular example, the current sampling and holding circuit, the compensation circuit, and the voltage sampling and holding circuit in this voltage sense control circuit may have substantially the same structure and connection relationship as above. In this example, the voltage sense control circuit may also include delay circuit 61 configured to generate delay time Tdelay according to voltage sense signal VIS. In addition, voltage sampling and holding circuit 42 may be used to sample and hold the output voltage feedback signal according to the delay time.

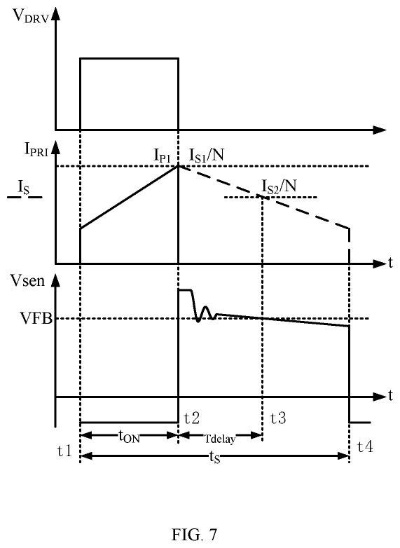

Referring now to FIG. 7, shown is a waveform diagram of example operation of the second example voltage sense control circuit, in accordance with embodiments of the present invention. In this particular example, tₛ may denote one switching cycle, t1 may denote the turn on time of the power switch at the primary side, and t2 may denote the turn off time of the power switch at the secondary side. The freewheeling current can begin to flow in the secondary side diode until the switching cycle ends at time t4. In this example, at the turn off time of the power switch (e.g., at time t2), current sampling and holding circuit 41 can sample the current through the power switch to obtain voltage sense signal VIS (e.g., VIS=I_{P1}×R4, where I_{P1} denotes the peak current of the power switch). Delay circuit 61 may generate delay time Tdelay according to voltage sense signal VIS, where delay time Tdelay is in proportion to voltage sense signal VIS. Voltage sampling and holding circuit 42 may be used to sample and hold voltage feedback signal VFB to obtain voltage feedback signal VFB after delay time Tdelay elapses after the power switch has been turned off.

In FIG. 7, peak current IP1 at the current sampling moment can be equal to peak current I_{S1} of the secondary side diode divided by the turn ratio N of the primary winding to the secondary winding of the transformer (e.g., I_{P1}=I_{S1}/N, where N=Np/Ns, and delay time Tdelay are in proportion to voltage sense signal VIS). That is, the delay time is relatively short when voltage sense signal VIS is relatively small, and the delay time is relatively long when voltage sense signal VIS is relatively large. Thus, after delay time Tdelay has elapsed, voltage feedback signal may be sampled at time t3, and current I_{S2} through the secondary side diode can be in proportion to voltage sense signal VIS. As such, the current information of the secondary side diode may be obtained at the primary side according to voltage sense signal VIS at the moment (e.g., point in time) of sampling the output voltage. Also, information about forward voltage drop VF of the diode may be obtained according to voltage sense signal VIS.

For example, current signal I_{S2} consistent with the forward voltage drop of the diode can be obtained at the moment of sampling the output voltage by regulating the proportion factor of the current controlled current source, so as to obtain a compensation signal consistent with the forward voltage drop of the diode. In this example, the moment of sampling voltage feedback signal VFB may be determined according to voltage sense signal VIS that represents the information as to the forward voltage drop of the diode. Thus, the compensation signal may effectively cancel out the influence on the output voltage feedback signal caused by the voltage drop of the diode at the moment of sampling the output voltage. As a result, good regulation of the output voltage may be achieved due to voltage feedback signal VFB being relatively accurate.

Also in particular embodiments, a voltage sense control method can be applied in an isolated converter. The isolated converter may include a transformer having a primary winding and a secondary winding, a power switch coupled with the primary winding, and a rectifier device coupled with the secondary winding. In one embodiment, a voltage sense control method may include sampling a current through the power switch to obtain a first voltage sense signal (e.g., VIS) in proportion to a voltage drop of the rectifier device.

A compensation signal can be generated according to a first current signal (e.g., IS1), where the first current signal is generated according to voltage sense signal VIS. A first voltage feedback signal (e.g., VFB) can be generated by compensating the output voltage feedback signal via the compensation signal. Voltage feedback signal VFB can be sampled and held in order to regulate an output voltage of the isolated converter to be substantially stable. Furthermore, at the turn on moment of the power switch, the current through the power switch can be sampled in order to generate voltage sense signal VIS. When the freewheeling current stops flowing in the rectifier diode, or the switching cycle of the power switch ends, voltage feedback signal VFB can be sampled and held.

Furthermore, at the turn off moment of the power switch, the current through the power switch can be sampled in order to obtain voltage sense signal VIS. A delay time can be generated according to voltage sense signal VIS, and voltage feedback signal VFB can be sampled and held after the delay time has elapsed after the power switch has been turned off, in order to obtain voltage feedback signal VFB at such a current moment.

The generation of the compensation signal can also include generating a first current signal (e.g., IS1) on a first resistor (e.g., R1) by voltage sense signal VIS, and generating a second current signal (e.g., IS2) in proportion to the first current signal. Information about the output voltage of the isolated converter can be obtained by an output voltage feedback circuit, in order to generate the output voltage feedback signal. The compensation signal can be obtained by generating a voltage drop on the voltage dividing resistors of the output voltage feedback circuit by the second current signal.

Certain embodiments can also include an isolated converter having a control circuit and a power stage circuit, and a voltage sense control circuit as described above. The isolated converter can achieve relatively good regulation of the output voltage, as well as relatively high control precision under different operation modes.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

1.-11. (canceled)

12. A primary control circuit configured for an isolated converter having a transformer including an auxiliary winding, a primary winding and a secondary winding, a power switch coupled to said primary winding, and a rectifier device coupled to said secondary winding, the primary control circuit comprising:
a) a compensation signal generating circuit configured to generate a compensation signal in accordance with a current flowing through said power switch that is sampled when said power switch transitions from an on state to an off state;
b) a voltage sampling and holding circuit being configured to generate a voltage feedback signal in accordance with an output voltage feedback signal representative of a voltage across said auxiliary winding and said compensation signal such that said voltage feedback signal is independent of a forward voltage drop of said rectifier device, wherein the timing of when said voltage feedback signal is generated is controlled in accordance with said current flowing through said power switch; and
c) a control circuit configured to control states of said power switch in accordance with said voltage feedback signal and a reference voltage to maintain an output voltage of said isolated converter as substantially constant.

13. The primary control circuit of claim 12, wherein:
a) said compensation signal is in direct proportion with said current flowing through said power switch; and
b) said voltage feedback signal is generated by subtracting said compensation signal from said output voltage feedback signal.

14. The primary control circuit of claim 12, wherein:
a) said compensation signal is in direct proportion with said current flowing through said power switch; and
b) said reference voltage is generated by adding said compensation signal to an expected voltage of said isolated converter.

15. The primary control circuit of claim 12, further comprising a delay circuit configured to generate a delay time having a time length that is controlled by said current flowing through said power switch at a turn off moment of said power switch, wherein said voltage feedback signal is generated after said delay time has elapsed after said power switch is turned off.

16. The primary control circuit of claim 15, further comprising a current sampling and holding circuit configured to sample said current flowing through said power switch to generate a voltage sense signal at said turn off moment.

17. The primary control circuit of claim 16, wherein said voltage sampling and holding circuit is configured to sample and hold said voltage feedback signal at a moment determined by said voltage sense signal.

18. The primary control circuit of claim 16, wherein said delay circuit is configured to receive said voltage sense signal, and to generate said delay time for said voltage sampling and holding circuit based on said voltage sense signal.

19. The primary control circuit of claim 12, wherein said voltage sampling and holding circuit is configured to sample said voltage feedback signal during a secondary current flowing through said secondary winding is decreased from a maximum value to a minimum value.

20. The primary control circuit of claim 12, wherein said compensation signal generating circuit comprises:
a) a resistor; and
b) a current controlled current source coupled in series with said resistor, and being configured to receive a voltage sense signal representative of said current flowing through said power switch, in order to generate said compensation signal.

21. The primary control circuit of claim 20, further comprising a resistor divider coupled to said auxiliary winding, and being configured to receive an output current of said current controlled current source, in order to change said voltage feedback signal in accordance with said output current.

22. The primary control circuit of claim 20, wherein said compensation signal is regulated by changing a value of said resistor, or changing a proportion factor of said current controlled current source.

23. A primary control method configured for an isolated converter having a transformer including an auxiliary winding, a primary winding and a secondary winding, a power switch coupled to said primary winding, and a rectifier device coupled to said secondary winding, the method comprising:
a) generating a compensation signal in accordance with a current flowing through said power switch that is sampled when said power switch transitions from an on state to an off state;
b) sampling a voltage across said auxiliary winding to generate an output voltage feedback signal;
c) generating a voltage feedback signal in accordance with said output voltage feedback signal and said compensation signal such that said voltage feedback signal is independent of a forward voltage drop of said rectifier device, wherein the timing of when said voltage feedback signal is generated is controlled in accordance with said current flowing through said power switch; and
d) controlling states of said power switch in accordance with said voltage feedback signal and a reference voltage to maintain an output voltage of said isolated converter as substantially constant.

24. The method of claim 23, wherein:
a) said compensation signal is in direct proportion with said current flowing through said power switch; and
b) said voltage feedback signal is generated by subtracting said compensation signal from said voltage sense signal.

25. The method of claim 23, wherein:
a) said compensation signal is in direct proportion with said current flowing through said power switch; and
b) said reference voltage is generated by adding said compensation signal to an expected voltage of said isolated converter.

26. The method of claim 23, wherein said voltage feedback signal is generated in accordance with said current flowing through said power switch when a secondary current flowing through said secondary winding is decreased from a maximum value to a minimum value.

27. The method of claim 23, further comprising generating a delay time having a time length that is controlled by said current flowing through said power switch at a turn off moment of said power switch, wherein said voltage feedback signal is generated after said delay time has lapsed after said power switch is turned off.

28. The method of claim 27, further comprising:
a) sampling said current flowing through said power switch to generate a voltage sense signal at a turn off moment of said power switch; and
b) generating said delay time based on said voltage sense signal.

29. The method of claim 28, further comprising:
a) generating a first current signal based on said voltage sense signal through a resistor;
b) generating a second current signal in proportion to said first current signal; and
c) obtaining said compensation signal by generating a voltage drop on voltage dividing resistors by said second current signal, wherein said voltage dividing resistors are coupled to said auxiliary winding.
